(19) United States
(12) Patent Application Publication
(10) Pub. No.: US 2008/0238667 A1
(43) Pub. Date: Oct. 2, 2008

(54) Clothing and Accessories that Operate Radio Frequency Identification Enabled Security Devices

(75) Inventor: Todd Olson, San Diego, CA (US)

Correspondence Address: DLA PIPER US LLP, 4365 EXECUTIVE DRIVE, SUITE 1100, SAN DIEGO, CA, 92121-2133, US

(73) Assignee: Proxwear, LLC, San Diego, CA (US)

(21) Appl. No.: 12/056,214

(22) Filed: Mar. 26, 2008

Related U.S. Application Data
(60) Provisional application No. 60/920,899, filed on Mar. 30, 2007.

(51) Int. Cl. G08B 13/00

(52) U.S. Cl. 340/541

(57) ABSTRACT

A wearable radio frequency identification (RFID) device is disclosed that includes a wearable housing and an RFID chip within the wearable housing. The RFID chip is configured to communicate with one or more RFID enabled security devices to activate and/or deactivate one or more security systems. The wearable RFID device may take on many different wearable forms, for example, a watch, a ring or a label with an RFID chip inside.

### CROSS REFERENCE TO RELATED APPLICATION(S)

This application claims the benefit of priority under 35 U.S.C. §119(e) of U.S. Ser. No. 60/920,899, filed Mar. 30, 2007, the entire contents of which are incorporated herein by reference.

### BACKGROUND OF THE INVENTION

1. Field of the Invention

The present invention relates to clothing and accessories that operate radio frequency identification enabled security devices. Specifically, it relates to wearable devices that are directed to keyless entry, automation and security/home automation. More specifically, it relates to a wearable device having a radio frequency identification (RFID) chip within, such as a watch, ring or label, such that the wearable device acts as a universal remote for all security and automation (auto, home, business) devices.

2. Background Information

The preverbal keychain of life is getting bigger and bigger everyday. The more technology evolves, so increases the need to operate and gain access to these technologies. Whether it's the common car or truck, a domestic home or corporate office, the need for automation is becoming more and more less a luxury and more of an everyday feature.

There are places in today's environment in which people must gain secure access to cars, home, office, etc. For example, many modern automobiles have keyless entry and ignition system that have become commonplace along, with air conditioning and power windows. These keyless systems are typically tied into the car's ignition and/or alarm system and will not allow the car to start without the use of an RF transmitter enabling the ignition to turn over. These systems eliminate the need for a physical key in most models. In addition, many modern homes and workplaces also use keyless electronic devices for entry, such as a garage door opener, key cards and security alarm. Each of these typically requires separate devices and all of them must be secured against theft or unwanted usage. And each of these devices takes up space.

One of the current challenges with these products is that the modern slim pocket stows or temporary storage devices overlook the space needed to accommodate the wireless transmitter, such as a RF transmitter, for the truly active. Also, for those individuals swimming, boating or surfing—taking the transmitter into the water is out of the question as most are not water resistant nor water proof.

It would be desirable to consolidate multiple wireless devices used in security and automation devices with multiple functionalities in one wearable device that provides a stand alone function.

### SUMMARY OF THE INVENTION

According to one embodiment of the present invention, a Radio Frequency Identification (RFID) watch is provided, the RFID watch includes a watch body housing and an adjustable band. The RFID watch may include one or more programmable buttons to communicate with security devices, and other devices. The RFID watch may be programmed to specific alarm units for a car, boat, airplane, etc., or may operate home security apparatus, business security apparatus or computer security apparatus.

In some embodiments, the RFID watch may be programmed for use with multiple items, such as for more than one security apparatus, for example a car and home security, etc., with custom configurations available depending on integrated security or keyless entry access point installed.

In some embodiments, the RFID watch body housing includes a slot configured to receive a RF transmitter chip and the watch body housing is also able to control the functions of chip. The RF transmitter chip may include one or more function and may be programmable or pre-configured. The RF transmitter chip turns the watch into a remote control device for one or more security devices programmed into the RF transmitter chip, such as a car, home, business, computer, etc. The watch may have one or more buttons to control the functions of the RF transmitter chip.

According to another embodiment of the present invention, a wearable device is provided that includes a wristband that is configured to work with an existing car alarm transmitter, such as a RF transmitter. The wearable device accepts an individuals existing RF transmitter into a cradle that is fused with an adjustable wristband. The wearable device comes with a quick release for the individual's existing RF transmitter allowing the user to quickly separate their keys from the unit.

According to another embodiment of the present invention, an RFID ring is provided that includes a ring body with an RFID chip, either embedded into the ring or inserted into the ring body, such as through a slot similar to the RFID watch above. The RFID ring may also include one or more lights or status indicators. The RFID ring may also include wireless communication capability so that the chip may be programmed via the wireless communication. In use, the RFID ring acts as a security pass, accessing alarms, computers, doors, etc.

According to another embodiment of the present invention, an RFID label is provided that includes an RFID chip. The RFID label may be sewn into or attached to many types of wearable items, for example, shirt, shorts, pants, sweatshirt, shoes, caps, gloves, wallets, etc. The RFID label with chip may be used for access and communication in the same way as the RFID watch and RFID ring embodiments disclosed above.

According to another embodiment of the present invention, wearable devices, such as the RFID watch, RFID ring, RFID label, and other embodiments described above, may initiate functions in a vehicle, such as open doors or windows, initiate auto seat folding, adjust the seat and/or adjust the pedals, and/or the wearable device may receive feedback from the vehicle.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 shows one embodiment of a Radio Frequency Identification (RFID) watch.

FIGS. 2 and 3 show another embodiment of an RFID watch.

FIG. 4 shows one embodiment of a wearable device configured to work with an existing alarm transmitter.

FIGS. 5 and 6 show one embodiment of a RFID ring.

FIG. 7 shows embodiments of a RFID label.

FIG. 8 shows the dash of a car configured to work with many embodiments of the wearable device.

### DETAILED DESCRIPTION OF THE INVENTION

The present invention is directed at wearable wireless devices that consolidate form and function to provide one device with multiple functions related to security devices. Another way of stating this is that the present invention is directed to the fusion of security and/or automation devices through the consolidation of multiple devices with multiple functionalities into one common discrete fashionable wearable device that provides the same multiple functions.

The present invention relies on wireless radio frequency identification (RFID) technologies to communicate, for example radio frequency (RF), Wi-Fi, Bluetooth, etc. The flexible nature of wireless technology is widely used, especially within the emerging active sports areas. With the widespread acceptance of wireless technological products surfacing every day, the wearable device of the present invention is designed to capitalize on the emerging wireless technology to fill the void in the marketplace. Through the connectivity of wireless devices and the pairing with home and business computer platforms, the wearable wireless devices of the present invention will be easy to configure and maintain.

Radio Frequency Identification (RFID) is a method of remotely storing and retrieving data using devices called RFID chips/tags/transponders. An RFID chip is a small object that can be attached to or incorporated into a wearable product. RFID chips contain antennas to enable them to receive and respond to radio-frequency queries from an RFID transceiver.

Wi-Fi is a term coined by the Wireless Ethernet Compatibility Alliance (WECA) and is another name for IEEE 802.11. Products certified as Wi-Fi by WECA are interoperable with each other even if they are from different manufacturers. A user with a Wi-Fi product can use any brand of Access Point with any other brand of client hardware that is built to the Wi-Fi standard.

Bluetooth is an always-on, short-range radio hookup that resides on a microchip and provides a universal short-range wireless capability. Using an available band, such as the 2.4 GHz band, two Bluetooth devices within 10 m of each other can share up to 720 Kbps of capacity. Bluetooth supports an open-ended list of applications, including data (such as schedules and telephone numbers), audio, graphics, and even video.

One of the novel features of the present invention lies in the wearable factor. Many security/automation devices leverage wireless technology, but none address the style factor of apparel and accessories designed for active individuals (i.e. water resistant, shock proof, and universal functionality for multiple devices). One concern for active individuals is a severe lack of personal storage space while engaging in rigorous activities. By utilizing wireless communications and wearable, fashionable technology—the present invention allows the user to have a “virtual keychain” fused directly to their body or clothing, mitigating the chances for dropping, misplacing or theft of the standard keychain. Working with wireless enabled security devices, the present invention will securely access wireless authentication and automation devices.

The present invention may be considered fashion forward user intuitive devices. Many current devices available today simply focus on the product functionality only. The present invention focuses on the user equally as functionally to dynamically bring form and function to user authentication and automation by consolidating the dated cumbersome keychain with a wearable universal digital keychain.

The wearable device may include many features/functions, such as:

The ability to tell time or accessorize easily and fashionably.

The ability electronically store virtual keys and pass-codes that enable access to virtually any wireless technology controlled device.

Control multiple devices with multiple functionality with one remote wearable device.

With the use of a wireless transmitter, the wearable device may control such things as: home automation; building automation; industrial automation; and/or vehicle automation via a wearable device having an RFID chip in a: wristwatch; ring; headwear; shirt; sweatshirt; shoes and/or eyewear.

The wearable device is a unique, scalable product and may have many embodiments and configurations.

In one embodiment, the wearable device is a wristband that is configured to work with an existing car alarm transmitter, such as a RF transmitter. The wearable device accepts an individuals existing RF transmitter into a cradle that is fused with an adjustable wristband. The wearable device comes with a quick release for the individual's existing RF transmitter allowing the user to quickly separate their keys from the unit. The user stores their keys inside their automobile and locks unlocks as usual.

In another embodiment, the wearable device is a RFID enabled sports wristwatch is able to be programmed to specific alarm units for car, boat, airplane, etc. The RFID watch may utilize Bluetooth technology that is becoming commonplace with today's electronics. In this embodiment, there is not need to push a button, the alarm senses the RFID watch when it is in close proximity. There may be buttons available for custom actions for vehicles, such as window operation, garage door, roof rack release, etc. The wearable device may be configured to work with multiple programmable items, such as for more than one car, boat, airplane, etc., with custom configurations available depending on integrated security or keyless entry access point installed.

While the present invention may be most receptive to automotive automation and security, the Home and Business Automation field is also viable. As direct programming and configuration for various devices and the need for synch capabilities would lend ubiquitously with Personal Computers, home and business security and authentication systems, Employee location and clock-in swiping.

When in proximity of other devices, the wearable device may be used to convey or receive information. For example the wearable device may be used for smart card proximity access or common access card, information exchange/tradeshow/social networking (entertainment), logistics/supply chain/quality assurance, healthcare and home monitoring. In the industrial and commercial area, the wearable device may communicate with monitors, sensors, automation equipment, control equipment, tracking equipment and may be used for secured entry and authentication.

The wearable device may be used for personal healthcare, in toys and games, in home automation, with pc and electronics (peripherals), with vehicles (motor bikes, bicycles, watercraft, and aircraft) and with secured storage/safes/deposit boxes.

Although the foregoing invention has been described in some detail by way of illustration and example for purposes of clarity and understanding, it will be apparent to those skilled in the art that certain changes and modifications may be practiced. Various aspects of the invention are described by way of the following non-limiting examples. Therefore, the description and examples should not be construed as limiting the scope of the invention, which is delineated by the appended description of exemplary embodiments.

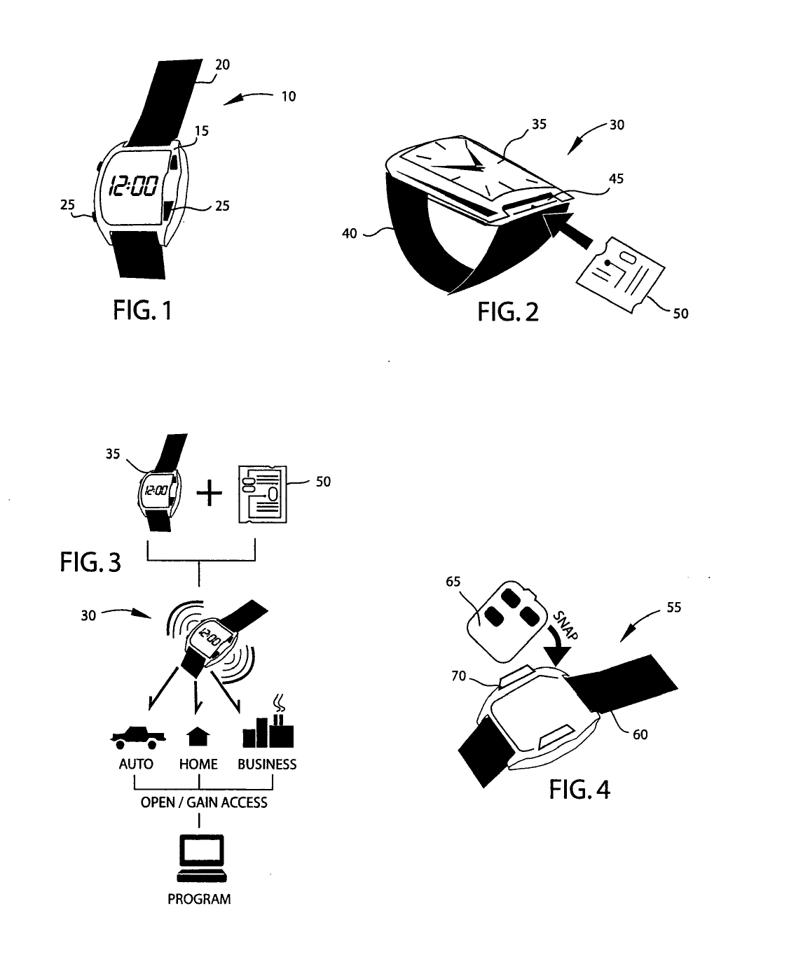

FIG. 1 shows one embodiment of a wearable device that is a Radio Frequency Identification (RFID) watch 10 that includes a watch body housing 15 and an adjustable band 20. The RFID watch 10 may include typical watch features, such as displaying the time and/or date, but it also incorporates a RF transmitter implemented into various watch body housings with one or more programmable buttons 25. One button 25 functions the RF transmitter to communicate with security devices, and other buttons are available for custom actions (window operation, garage door, roof rack release). The RFID watch 10 may be programmed to specific alarm units for a car, boat, airplane, etc., or may operate home security apparatus, business security apparatus or computer security apparatus. In other words, the RFID watch 10 acts as a universal remote for security devices. The programming may be done via wired (USB or other wired connection) or wireless communication (WI-FI, Bluetooth, RF) with another device, such as a computer. In some embodiments, the wearable device may be programmed for use with multiple items, such as for more than one security apparatus, for example a car and home security, etc., with custom configurations available depending on integrated security or keyless entry access point installed.

With the RFID watch 10, the wearer will have the ability to make sure they can track the time to monitor things, such as a running parking meter, and have peace that wireless access is securely strapped to their wrist rather than worry about keys in a pack on the shore or in a temporary storage device outside of a car.

FIGS. 2 and 3 show another embodiment of an RFID watch 30 that includes a watch body housing 35 and an adjustable band 40. In this embodiment, the watch body housing 35 includes a slot 45 configured to receive a RF transmitter chip 50 and the watch body housing also able to control the functions of chip 50. The chip 50 may include one or more function and may be programmable or pre-configured. The chip 50 turns the RFID watch 30 into a remote control device for one or more security devices programmed into the chip, such as a car, home, business, computer, etc. The RFID watch 30 may have one or more buttons to control the functions of the chip 50.

In the embodiment shown in FIG. 4, the wearable device 55 is a wristband 60 that is configured to work with an existing car alarm transmitter 65, such as a RF transmitter. The wearable device 55 accepts an individuals existing RF transmitter 65 into a cradle 70 that is fused with an adjustable wristband 60. The transmitter 65 may be held into the cradle 70 using known means, such as clips, taps, snaps, Velcro, etc. The wearable device 55 comes with a quick release for the individual's existing RF transmitter allowing the user to quickly separate their keys from the unit. The user stores their keys inside their automobile and locks unlocks as usual using the RF transmitter 65.

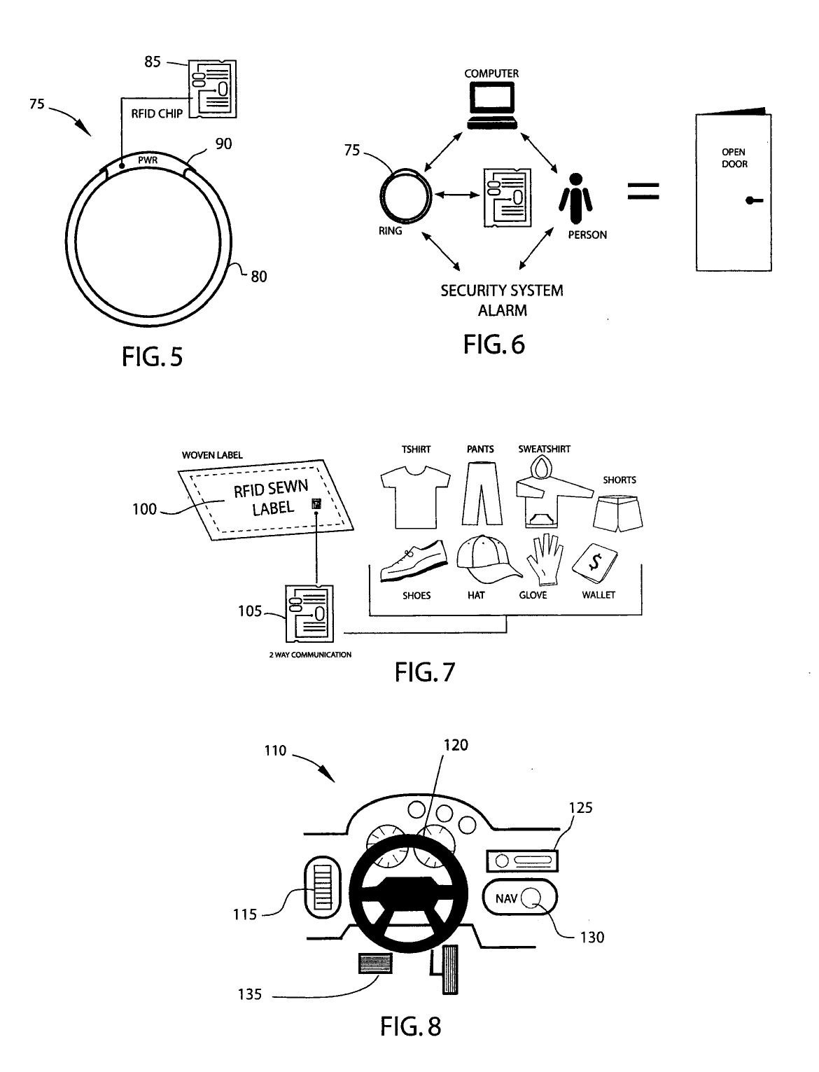

FIGS. 5 and 6 show an embodiment in which the wearable device is an RFID ring 75 that includes a ring body 80 with an RFID chip 85, either embedded into the ring or inserted into the ring body, such as through a slot similar to RFID watch 30 above. The RFID ring 75 may also include one or more lights or status indicators 90. The RFID ring 75 may also include wireless communication capability so that the chip 85 may be programmed via the wireless communication. In use, the RFID ring 75 acts as a security pass, accessing alarms, computers, doors, etc.

In another embodiment, shown in FIG. 7, the wearable device is a RFID label 100 that includes a RFID chip 105. The RFID label 100 may be sewn into or attached to many types of wearable items, for example, shirt, shorts, pants, sweatshirt, shoes, caps, gloves, wallets, etc. The RFID label 100 with chip 105 may be used for access and communication in the same way as the RFID watch and RFID ring embodiments disclosed above. In addition, the RFID label 100 with chip 105 further offers other features, such as authentication of the item, tracking of the item, item inventory control and management.

While the previously disclosed embodiments of the wearable device disclose use with different system for alarm and/or access, the wearable device may also control functions in a vehicle and/or receive feedback from a vehicle.

FIG. 8 is a schematic of the dash 110 in a vehicle having a security system 115, speedometer 120, a radio 125, a navigation/computer system 130 and adjustable pedals 135. In the embodiments disclosed below, wearable devices, such as 10, 30, 55, 75, 100 described above, may initiate functions in the vehicle, such as open doors or windows, initiate auto seat folding, adjust the seat and/or adjust the pedals, and/or the wearable device may receive feedback from the vehicle.

In one embodiment, the wearable device is configured to vibrate, alarm or provide some indication to the user when a pre-determined speed in the vehicle is reached. For example, the wearable device may vibrate if the speed reaches greater than 65 mph. The alarm speed limit may be input to the wearable device using buttons, or may be programmed from a computer, or even the vehicle can program the wearable device (many of the new vehicles include computer type controls in a navigation/computer system 130).

In another embodiment, the wearable device controls one or more functions in the vehicle. In one example, the vehicle recognizes the presence of wearable device, either by signaling or when the device is within close proximity, and adjusts one or more features in the vehicle in a pre-determined way. The features may include setting the radio station 125 and volume, adjust seats and pedals 135.

Although the foregoing invention has been described in some detail by way of illustration and example for purposes of clarity and understanding, it will be apparent to those of ordinary skill in the art in light of the teaching of this invention that certain changes and modifications may be made thereto without departing from the spirit or scope of the claims. Such variations and modifications are considered to be within the scope of the invention, which is intended to be limited only to the scope of the claims as interpreted according to the principles of patent law, including the doctrine of equivalents.

What is claimed is:

1. A wearable radio frequency identification (RFID) device comprising:
a wearable housing; and
an RFID chip within the wearable housing, the RFID chip being configured to communicate with one or more RFID enabled security devices to activate and/or deactivate one or more security systems.

2. The wearable device of claim 1, wherein the wearable housing is a watch housing having an adjustable strap configured to fit on a persons wrist.

3. The wearable device of claim 1, wherein the wearable housing is a ring housing configured to fit on a persons finger.

4. The wearable device of claim 1, wherein the wearable housing is a woven label configured to be couple with a wearable garment.

5. The wearable device of claim 1, wherein the wearable housing includes a slot configured to receive the RFID chip.

6. The wearable device of claim 1, wherein the wearable housing includes one or more buttons configured to control one or more features of the RFID chip.

7. The wearable device of claim 1, wherein the RFID chip is programmable.

8. The wearable device of claim 1, wherein the RFID chip is further configured to operate one or more features in a vehicle.
